(19) United States
(12) Patent Application Publication
(10) Pub. No.: US 2025/0147479 A1
(43) Pub. Date: May 8, 2025

(54) Safeguarding a machine

(71) Applicant: SICK AG, Waldkirch (DE)

(72) Inventors: Michael SCHOTT, Waldkirch (SA); Christoph HOFMANN, Waldkirch (DE); Alfred AROCKIARAJ, Waldkirch (DE)

(21) Appl. No.: 18/941,176

(22) Filed: Nov. 8, 2024

(30) Foreign Application Priority Data
Nov. 8, 2023 (EP) 23208452.5

(51) Int. Cl. G05B 19/048; G06V 10/764; G06V 10/774; G06V 10/82

(52) U.S. Cl. CPC G05B 19/048; G06V 10/764; G06V 10/774; G06V 10/82

(57) ABSTRACT

A method of safeguarding a machine is provided in which a sensor monitors the machine and generates data thereon that are evaluated so that a hazardous situation is recognized and the machine is safeguarded in the event of a hazardous situation, wherein a check is made in a detection capability check whether an estimation of a hazardous situation is possible and the machine is otherwise safeguarded. In this respect, the sensor data are evaluated in a process of machine learning having at least one figure of quality in the detection capability check and an estimation of a hazardous situation is only considered possible with a sufficient figure of quality.

The invention relates to a method of safeguarding a machine and to a corresponding safeguarding system.

The goal of the safeguarding is to protect persons from hazard sources such as, for example, machines in an industrial environment represent. The machine is monitored with the aid of sensors and accordingly, if a situation is present in which a person threatens to come dangerously close to the machine, a suitable safeguarding measure is taken. The safeguarding becomes particularly demanding in the case of cooperation between a person and a machine or robot.

Conventionally, primarily optoelectronic sensors such as light grids or laser scanners have been used for a safety engineering monitoring. More recently cameras and 3D cameras have also been used. A common safeguarding concept provides that protected fields are configured that may not be entered by operators during the operation of the machine. If the sensor recognizes an unauthorized protected field intrusion, for instance a leg of an operator, it triggers a safety-relevant stop of the machine. Other intrusions into the protected field, for example by static machine parts, can be taught as permitted in advance. Warning fields are frequently disposed in front of the protected fields where intrusions initially only result in a warning to prevent the intrusion into the protected field and thus the safeguarding in good time and so to increase the availability of the plant. Alternatives to protected fields are also known; for instance, taking care that a minimum distance is observed between the machine and the person that is dependent on the relative movement (“speed and separation”).

Sensors used in safety technology have to work particularly reliably and must therefore satisfy high safety demands, for example the EN13849 standard for safety of machinery and the machinery standard IEC61496 or EN61496 for electrosensitive protective equipment (ESPE). A number of measures have to be taken to satisfy these safety standards such as reliable electronic evaluation by redundant, diverse electronics, function monitoring, or specifically monitoring the soiling of optical components, in particular of a front screen, and/or provision of individual test targets with defined degrees of reflection which have to be recognized at the corresponding scanning angles. It is thus ensured by measures tailored to the specific sensor that the sensor data have sufficient quality to satisfy the detection object or otherwise reveals a defect preventing this.

EP 3 651 458 A1 discloses a safe stereo camera that checks the functionality of its image sensors. For this purpose, it has knowledge of a reference depth map and statistically evaluates the differences of the respective current depth map from the reference depth map. This only works in a static environment.

In DE 10 2018 117 274 A1, surroundings of the pixels are analyzed to determine when noise influences become too large for a safe detection of objects. A large number of reasons that can prevent object detection thus remain out of consideration.

Substantial progress has been achieved in the field of artificial neural networks quite independently of safety engineering in the past few years. This technology has reached a wide application maturity through new architectures of the neural networks (deep learning) and through the greatly increased available processor power in the form of modern graphics processors. An important challenge in the use of neural networks for a situation evaluation and problem solution is the necessity of training the neural network with representative training data. Before the neural network can reliably complete the object set, it has to be confronted with comparable situations and their predefined evaluation, The neural network learns the correct behavior With reference to these examples. In this respect, a neural network is only capable of a generalization within certain limits.

When neural networks are used in safety engineering, there are particular difficulties in demonstrating the detection capability and in revealing defects. If no safety critical object is recognized in the environment of the machine, this does not necessarily mean that there is no danger. It can rather be due to problems of the sensor or in the scene that an actually present object falsely remains unrecognized. Sensor errors can possibly be countered by technical measures similar to conventional safe sensors without neural networks. It becomes difficult when, for example, the illumination in a scene fails or when the scene is flooded with sunlight. A neural network then does not recognize any object, but it does not show the reason so that dangerous misjudgments can occur.

A method for generating training data for the monitoring of a hazard source is described in DE 10 2017 105 174 A1. In this process, a sensor that is safe in accordance with the classical viewpoint evaluates the respective situation so that annotated training data for the training of a neural network are then available. However, this has nothing to do with the question whether the image data to be evaluated in the later use of the neural network have sufficient quality.

The paper by Begon, Jean-Michel and Pierre Geurts, “Sample-free white-box out-of-distribution detection for deep learning”, Proceedings of the IEEE/CVF Conference on Computer Vision and Pattern Recognition, 2021, describes an approach how so-called OOD (out of distribution) examples can be detected. The internal activations of the neural network are analyzed for this. This is complex and not feasible in safety engineering practice.

Marco Pavone discusses the use of a plurality of deep neural networks with a comparison of the respective results in a conference contribution “Building Trust in AI for Autonomous Vehicles” at the Nvidia GTC Developer Conference of March 20-23. Despite the huge increased effort, this does not solve the problem for the safety application looked at here because an image of poor quality will also result in unreliable results in a plurality of neural networks.

The occurrence of unusable input data can be understood as an anomaly detection to a certain extent, as examined, for example, in the papers Chalapathy, Raghavendra, and Sanjay Chawla “Deep learning for anomaly detection: A survey”, arXiv preprint arXiv: 1901.03407 (2019) and Chalapathy, Raghavendra, Edward Toth und Sanjay Chawla, “Group anomaly detection using deep generative models”, Machine Learning and Knowledge Discovery in Databases: European Conference, ECML PKDD 2018, Dublin, Ireland, Sep. 10-14, 2018, Proceedings, Part I 18, Springer International Publishing, 2019. There is already a fundamental problem here in that there is as a rule an insufficient number of training examples for the anomaly.

How corrupt pixels can be located by a neural network is known from Kalyanasundaram, Girish, Puneet Pandey and Manjit Hota, “A Pre-processing Assisted Neural Network for Dynamic Bad Pixel Detection in Bayer Images”, Computer Vision and Image Processing: 5th International Conference, CVIP 2020, Prayagraj, India, Dec. 4-6, 2020, Revised Selected Papers, Part II 5. Springer Singapore, 2021. This is, however, only one of the possible defects and the conventional approach is directed to a correction of the corrupt pixels, whereas it should be determined in a safety application whether the defects are critical in the sense of accident avoidance.

It is therefore the object of the invention to improve the check of detection capability in a safety application.

This object is satisfied by a method and by a safeguarding system for safeguarding a machine in accordance with the respective claim. The machine is monitored by a sensor. In this respect, the machine and the sensor are only named in the singular as representatives; any desired complex safety applications with a plurality of sensors and/or machines are conceivable. The method is a computer implemented method that runs, for example, on a processing unit of the sensor and/or a connected processing unit. The sensor preferably works contactlessly and is in particular an optoelectronic sensor. The sensor and/or the hardware for evaluations is/are preferably designed as safe. Safe and safety mean, as in the total description, that measures are taken to control errors up to a specific safety level or to observe regulations of a relevant safety standard for machine safety or for electrosensitive protective equipment, of which some have been named in the introduction. Unsafe is the opposite of safe and accordingly said demands on failsafeness are not satisfied for unsafe devices, transmission paths, evaluations, and the like.

Whether a hazardous situation is present is determined by evaluating the sensor data. If it is the case, the machine is safeguarded. A hazardous situation is in particular present when an object or a person is too close to the machine. Some concepts such as protected field monitoring or speed and separation monitoring have been named in the introduction; a further example is safe object tracking with dangerous and non-dangerous trajectories of objects in the environment of the machine and an evaluation of the sensor data by a process of machine learning is also conceivable, as explained more exactly below. A safeguarding of the machine can comprise, depending on the safety application, the recognized hazard, and further possible criteria, a slowing down, an evasion, a switch to a different program, or, where necessary, the stopping of the machine.

The detection capability is furthermore checked, that is whether as estimation of a hazardous situation is currently possible at all. Otherwise, the machine is also safeguarded for this reason, analogously to the case of a recognized hazardous situation, and with the same possible safeguarding measures. It is here a question of a safety related failure of the detection capability, not a possible only very brief interference. What is decisive is that the safeguarding has to respond fast enough, in particular in the response time predefined by the safety application. Conventional measures for this have been discussed in the introduction and are also conceivable in accordance with the invention, but are per se insufficient, for example a failure of the sensor, lack of permeability of optical components, an image sensor test, and the like.

The invention starts from the basic idea that the detection capability is checked using the sensor data and by a process of machine learning. Machine learning here means as usual as an antonym to a classical evaluation a data driven approach in which evaluation strategies are not developed by hand, but were taught from examples. The result of the evaluation of the sensor data by the process of machine learning is a figure of quality. It must satisfy a specification that corresponds to a sufficient quality of the sensor data by which the evaluation of the sensor data is possible with respect to a hazardous situation.

The invention has the advantage that it can be reliably determined whether the sensor is functional and whether its detection zone, that is the scene in the environment of the machine, simultaneously permits a hazard evaluation using the sensor data. The safeguarding can thus be trusted, in particular also when a process of machine learning participates in the evaluation of the sensor data for the actual hazard evaluation. The visual perception of humans can be used as an analogy: In the dark, in the wet, or without eyeglasses, a human would act very much more carefully. The invention allows the safety application to recognize that it is in a comparable exceptional situation. In this respect, the invention also copes with dynamic scenes, unlike some of the approaches named in the introduction. The balance from when the detection capability should no longer be present can be set very finely. This is important because safety admittedly has priority, but too careful an evaluation due to objectively unnecessary safeguarding measures results in substantial losses in availability or productivity.

The figure of quality is preferably binary. It therefore directly distinguishes only between the two cases that an estimation of a hazardous situation is possible or is not possible. Subsequent to the detection capability check of the process of machine learning, no further evaluation is thus necessary, the binary decision or classification has already been made. It must again be repeated that a negative result of the detection capability check does not have to directly result in a safeguarding. With a camera as the sensor, for example, a decision on the safeguarding can always only be made after evaluation of n images or frames, with then insufficient quality in a single image or in a few images possibly still being tolerable.

The figure of quality preferably quantitatively evaluates at least one interference property of the sensor data. Such a figure of quality is, for example, a number in a certain value range such as [0, 1, . . . , 10] or a percentage. It evaluates a certain interference property or corruption modality of the sensor data and it can then be very simply derived therefrom by a comparison with predefined criteria as to whether the quality of the sensor data is sufficient for an estimation of the hazardous situation or not. It must be noted at this point that there can be a plurality of figures of quality or the figure of quality can be multidimensional. The respective components can evaluate different interference properties. A simultaneously binary and quantitatively differentiating figure of quality is also accordingly not a contradiction, but is rather possible and then relates to different components. The quantitative components then, for example, enable a consistency check of the binary component or an analysis of how this evaluation was reached. The latter is in particular of interest in the sense of “explainable AI”.

The process of machine learning preferably has a classifier. The assignment of a figure of quality can be understood as a classification and indeed in both cases of a binary figure of quality and of a differentiated, quantitatively evaluating figure of quality. There are a large number of processes of machine learning for classification work, for example decision trees, support vector machine, K-nearest neighbor, or Bayes classifiers. It is conceivable to use a plurality of classifiers or processes of machine learning in general, that are then responsible for one or more interference properties, in a dividing or (partially) overlapping manner. A process of machine learning can then be optimized specifically for certain interference properties.

The process of machine learning preferably has a neural network. A neural network, in particular a deep neural network (deep learning) or a convolutional neural network (CNN) is very well suited to also evaluate or especially to classify complex sensor data such as images or 3D point clouds.

The sensor is preferably a camera or a 3D sensor. These sensors deliver a great deal of information on the environment of the machine and can therefore solve a variety of safety applications. The sensor data are correspondingly images or image data in the event of a conventional camera or 3D point clouds or depth maps in the case of a 3D sensor, that is, for example, a 3D camera, a LiDAR, a laser scanner, or radar.

The evaluation of the sensor data preferably has an object detector that in particular recognizes foreign objects in the environment of the machine. A camera or a 3D sensor is preferably used here. An unknown or unexpected object in the environment of the machine is termed a foreign object. Depending on the safety application, every recognized object is considered as a foreign object; known objects are taught as a reference in advance or expected objects are dynamically recognized as such and are distinguished from foreign objects. Whether a recognized object signifies a hazardous situation is likewise dependent on the safety application. Some possible criteria are the size, shape, position, speed, or trajectory of the object.

The process of machine learning is preferably trained by supervised learning in which a plurality of training examples from sensor data having a known associated figure of quality are used as the training data. Supervised learning means that the desired result, in this case the figure of quality matching a set of sensor data of a training example, is specified from outside. The training preferably takes place prior to the actual safeguarding operation, but can also be refined or deepened in operation or in operation breaks. The process of machine learning using the training examples learns the association of a figure of quality with respect to sensor data in the training and is able to transfer it to the sensor data unknown from the training after the training.

The training examples are preferably changed by at least one interference property in at least one interference intensity to generate further training examples. The initially present training examples are therefore subject to interference or corrupted in a targeted manner to obtain further training examples. The interference can take place in different manners, that is in different interference properties or corruption modalities, and/or can be of different strengths, as expressed by a interference intensity. When a quantitatively evaluating figure of quality is later determined by the process of machine learning, it can agree with the interference intensity, but different scales are also conceivable.

The sensor data preferably have images and at least one of the following interference properties is used: Image is at least regionally too light or too dark, image is at least regionally blurred, movement artifacts, static or/and dynamic image noise, image regions swapped over, in particular by address errors, image incomplete. The previously very abstract term of interference property is thus illustrated by examples. A change in an interference property could therefore then comprise brightening the image artificially to a different degree predefined by the interference intensity, also in any desired combination correspondingly for the other named examples. Interference in two dimensions is therefore possible that is present, on the one hand, by the selection of the interference property, in particular from a list as in the named examples, and, on the other hand, by the extent of the interference or the interference intensity. The safety application is the more robust, the better the interference properties map the interference or error cases possible in reality. A list of considered interference properties is therefore exclusive in the ideal case. Since this is not possible in practice, the most important interference properties are instead identified and considered.

However, to a certain extent, the process of machine learning can also generalize so that by no means every scene not considered in detail in advance and therefore not explicitly mapped in the training data immediately results in an overlooked hazard.

The training data are preferably evaluated, in particular by an object detector, to determine whether a hazardous situation is recognized despite the interference property and a figure of quality is associated with a training example depending on the result. The requirement for supervised learning is the specification of the desired result, which is called labeling or annotating, and is as a rule an extremely laborious and complex manual procedure. In particular in the case of artificially generated or changed data, as described in the previous paragraph, there is initially no matching label, that is the associated figure of quality, since it is not known a priori whether the estimation of a hazardous situation is still possible or not after a change. In accordance with this embodiment, the annotation is performed automatically by evaluation, that hazard assessment, using the sensor data of the training example and in particular an object detector. The label for the original training example not changed or corrupted by interference is known. It is in particular determined in the evaluation for automatic annotation whether this label is still reproduced or whether the corruption was too strong for this.

The training data are preferably evaluated by the same process that is also used for recognizing a hazardous situation in the safeguarding of the machine.

Evaluation at this point means the automatic labeling or annotating of the previous paragraph. In principle, this could be carried out with any evaluation process or object detector. However, actually that evaluation is particularly preferably used that is also used in the actual operation. There is thus a particularly good agreement in the evaluation of sensor data with respect to the question whether the quality of the sensor data is sufficient for the hazard evaluation or not. It is conceivable to use a plurality of evaluations or object detectors whose labels are then combined.

The training data are preferably changed with increasing interference intensity and/or different interference properties until an evaluation of the changed training data no longer recognizes a hazardous situation. There is in particular a special interest in borderline cases, in which interference actually just or actually no longer allows an evaluation, in particular an object detection, for the evaluation of whether a recognition of a hazardous situation is still possible with a certain set of sensor data. If these borderline cases are correctly assessed, this all the more applies to simpler cases remote from the border. This border is therefore advantageously tested by different interference properties and/or interference intensities, for example in an iterative process that tries out the most varied combinations of interference properties one after the other and increases their respective interference intensity or, which should be implied by the term “increasingly”, systematically changes them in any other manner.

A Figure of quality is preferably already associated with training examples corresponding to a no longer present detection capability in which the evaluation has still recognized a hazardous situation to provide a safety margin. A spacing from the border explained in the previous paragraph is thus intentionally observed and only those sensor data are as a precaution considered sufficient by the detection capability check that at least overfill the criteria a little. If, for example, a interference property was quantified in the range of 0 . . . 10 and if the border of the no longer present detection capability was found at 7, a much stronger demand of a interference property of at most 5 is made instead of the testing correspondingly at the border at 7 at the most. This serves the improved dealing with a possible fatal error that the detection capability check incorrectly considers sensor data as still sufficient for an estimation of a hazardous situation, but an actually present hazard is overlooked due to insufficient quality of the sensor data in the actual evaluation or object recognition. More false negative results of the detection capability are therefore accepted to prevent false negative results of the hazard assessment.

The evaluation of the sensor data for the recognition of a hazardous situation preferably likewise has comprises a process of machine learning. Which method recognizes whether a hazardous situation is present had previously remained open, except that it is preferably based on an object detection and some examples have been named in the introduction. A process of machine learning is used by this embodiment not only for the detection capability check, but also for the estimation of a hazardous situation. The same processes of machine learning can be used that were named above, in particular a neural network. The process of machine learning of the detection capability check is particularly preferably also used for the recognition of a hazardous situation in a dual function and is accordingly previously trained. A function, for instance the detection capability check, is advantageously only subsequently trained. There is, for example, an already trained neural network for an object detection and an additional outcome for the classification of the sensor data is added to this in the sense of the detection capability check and this is subsequently trained.

The safeguarding system in accordance with the invention has at least one sensor for monitoring the machine and for generating sensor data and at least one control and evaluation unit. Control and evaluation unit means any desired processing unit that can be part of the sensor, of the machine, independently, or a mixed form thereof. A method in accordance with the invention is implemented therein in the described embodiment.

The invention will be explained in more detail in the following also with respect to further features and advantages by way of example with reference to embodiments and to the enclosed drawing. The Figures of the drawing show in:

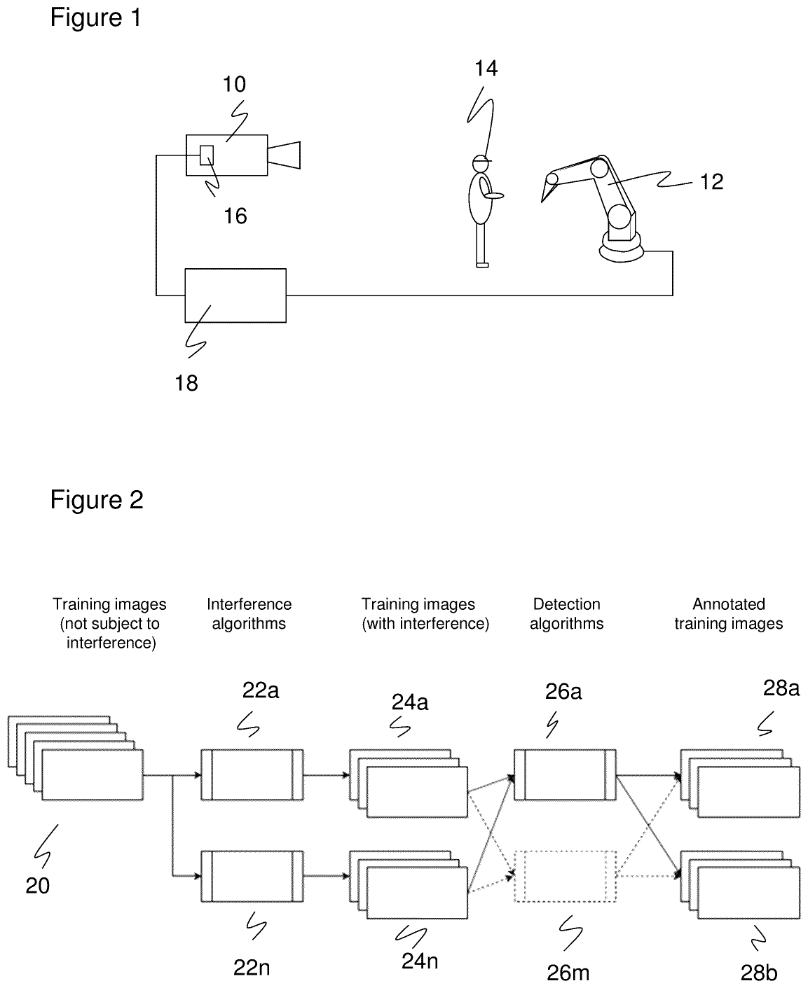

FIG. 1 an overview representation of an exemplary safeguarding of a machine by a sensor;

FIG. 2 a representation of the targeted interference of training data and of the automatic annotation whether the recognition of a hazardous situation is still possible with the respective training data subject to interference; and

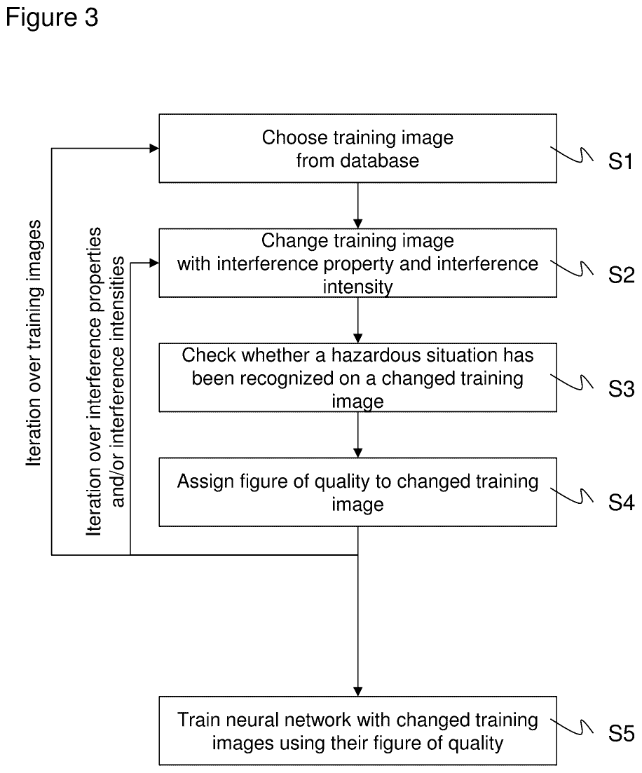

FIG. 3 an exemplary flowchart of the changing and annotating of training data and of the training of a neural network for a detection capability check made possible by it.

FIG. 1 shows an exemplary safety application in which a camera 10 monitors a robot 12. The camera 10 and the robot 12 are examples for a monitoring sensor or for a machine to be monitored. The sensor data generated by the camera 10 are evaluated to recognize whether a hazardous situation is present, in particular whether a person 14 comes too close to the robot 12. If a hazard is recognized, a safeguarding measure is initiated that slows down the robot 12, causes it to evade, switches to a program having a different work zone or to a non-dangerous movement, or fully stops the robot 12 if necessary.

The evaluation of the sensor data is preceded by a detection capability check in which a decision is made whether the sensor data allow the estimation of a hazardous situation at all. The quality of the sensor data is namely not always sufficient for this for reasons that may in particular lie in the camera 10 or in the scene in the environment of the robot 12. The detection capability check uses a process of machine learning and will be explained in more detail below together with its training with reference to FIGS. 2 and 3.

The evaluations take place in a processing unit which can be at least an internal processing unit 16 of the camera 10, at least a connected extremal processing unit 18, or a combination of the two. Examples for an internal processing unit are digital processing modules such as a microprocessor or a CPU (central processing unit), an FPGA (field programmable gate array), a DSP (digital signal processor), an ASIC (application specific integrated circuit), an AI processor, an NPU (neural processing unit), a GPU (graphics processing unit), a VPU (video processing unit), or the like. An external processing unit can be a computer of any desired kind, including notebooks, smartphones, tablets, a (safety) controller, equally a local network, an edge device, or a cloud. There is also a large selection with respect to the communication links, for instance I/O-Link, Bluetooth, wireless LAN, Wi-Fi, 3G/4G/5G, and in principle any industry suitable standard.

The invention will be described with a camera 10 as an example for a monitoring sensor; the sensor data are corresponding images by way of example. Other sensors are conceivable, in particular a 3D sensor that generates a 3D point cloud or depth map as the sensor data.

At least the detection capability test, in a preferred further development of the invention also in a dual function the evaluation of sensor data whether a hazardous situation is present, is based on a process of machine learning. A neural network is used in the following by way of example and representative of any process of machine learning known per se, in particular for a classification. In a brief description, an input image is supplied to the detection capability check and the neural network provides feedback, called a figure of quality, on whether this input image is usable for a different detection algorithm, namely the estimation whether a hazardous situation is present. That detection algorithm can, as already addressed, be a classical image processing process or likewise a process of machine learning. This can essentially be an object recognition, but can also contain other and in particular more advanced evaluations such as object tracking, person recognition, pose determination, facial recognition, or code reading.

At least three scenarios can be distinguished with the detection capability check and the subsequent evaluation whether there is a hazardous situation: First, no person or other object considered hazardous may be present and this is also correctly recognized. The robot 12 can then work without impediment. Second, a person or another foreign object can have been correctly recognized in a hazardous situation. The robot 12 must then be safeguarded. Third, the detection capability check must arrive at a negative result. It then no longer has to be differentiated whether a hazardous situation is recognized or not with the images recognized as qualitatively insufficient because this statement would anyway not be credible. The robot must also be safeguarded now, with other measures being able to be taken than in the case of a recognized hazard situation. An instantaneously lacking detection capability is a potential hazard and thus less critical than an already explicitly recognized hazard situation.

FIG. 2 illustrates the training of the detection capability check and shows for this purpose a representation of the targeted interference of training data and of the automatic annotation whether the recognition of a hazardous situation is still possible with the respective training data subject to interference. The starting point is formed by training images 20 not subject to interference that are preferably acquired form real sensor data and that are initially not further manipulated. The training images 20 not subject to interference should include both those in which a hazardous situation has been detected, in particular an object or a person in a situation not permitted for safety reasons, and those without a hazardous situation or without a foreign object. The background should preferably be that of the safety application or at least be sufficiently similar. In addition it is preferably known in advance for the supervised learning which of these two classes a training image 20 belongs to, with this alternatively also only being able to be automatically determined in the further course. Such training examples can only be acquired with a lot of effort and are therefore not present in sufficient number in practice. This above all applies to the diverse error cases and interference looked at here.

To acquire sufficient training images that are subject to interference or corrupted in different matters and to a different degree, the training images 20 not subject to interference are subjected to at least one interference algorithm 20a-n. This follows a similar idea to augmentation (data augmentation) by which a training dataset is increased in size in a known manner by artificial changes. In the present case, however, unlike a conventional augmentation, it is very directly a question of teaching the process of machine learning to evaluate such interference or changes as part of the detection capability check. An interference algorithm 22a-n manipulates at least one interference property or corruption modality of the training image with a interference intensity that can be fixed.

To enable a reliable detection capability check, the list of considered interference properties should be as complete as possible, that is should map all the relevant interference that could occur in operation. This is not always possible, but the ability of a neural network to compensate any gaps helps here. The following list of interference can be given for images as a further used example of sensor data that is still not absolutely exhaustive, but is comprehensive enough for a number of safety applications. The image is too light or too dark, the image is at least regionally blurred, the image contains motion artifacts or image noise, image regions have been swapped over, or the image is incomplete.

Training images 24a-n subject to interference or corrupted are produced in a well-defined manner with the aid of the at least one interference algorithm 22a-22n.

Since there are a plurality of interference algorithms 22a-n and every one can perform its interference at different interference intensities, a great deal more training images 24a-n subject to interference can be acquired than the initially present training images not subject to interference. In addition, the training images 24a-n subject to interference directly contain just those features that are to be trained.

To not have to evaluate the training images 24a-n subject to interference by hand, which is not precluded, they are subjected to at least one algorithm 26a-m. It is, for example, an object detector or another method for evaluating whether there is a hazardous situation. It is preferably that method that will also be used later in operation for the estimation of hazardous situations. This follows the heuristics that the criteria for the evaluation of the detection capability would then have to be most suitable. A diversification in a plurality of directions is, however, conceivable: When training or in operation, a plurality of processes can be used, with them being able to partially distinguish training and operation from another or not. This also supports the ability of the neural network trained in this manner to generalize to unknown situations.

The training images 24a-n subject to interference are now labeled or annotated with the aid of the at least one detection algorithms 26a-m. Whether it is respectively an example for an image that allows the evaluation of a hazardous situation or whether the interference is too great for this is therefore known. The training images subject to interference are so-to-say sorted into two pots for positive examples 28a and negative examples 28b.

FIG. 3 shows supplementary to FIG. 2 an exemplary flowchart of the changing and annotating of training data and of the training of a neural network for a detection capability check made possible by it. In a first step S1, a training image 20 not subject to interference is selected from the initially present database having training examples, in particular from real data.

In a step S2, the training image is subject to interference or corrupted. The corresponding interference algorithms 22a-22n have already been described with reference to FIG. 2. The training image is modified by a interference property or by a combination of interference properties, with most interference properties not binarily complementing an interference property, but rather gradually changing the training image with a interference intensity 22a-22n.

The respective resulting training image 24a-n subject to interference is evaluated in a step S3 as to whether a hazardous situation has been recognized in it. That evaluation is preferably used for this purpose that will also be used in operation. The detection capability check is thus checked for a specific, namely the relevant, detection algorithm 26a-m, with a plurality of detection algorithms 26a-m being able to be used, as mentioned with reference to FIG. 2. It is also conceivable that the neural network of the detection capability check pretrains with general object detectors and then a post-training is carried out in an application-specific manner using the evaluation process provided for a specific safety application to evaluate a hazardous situation.

It is determined in a step S4 whether a hazardous situation was able to be recognized. This can per se be the result. A figure of quality is therefore associated with the training image as a label, from which it can be seen that the recognition of a hazardous situation was possible or that it is a positive example 28a and a non-recognized hazardous situation would accordingly be a negative example 28b. However, an alternative is more robust in which it is known of the originally training images 20 not subject to interference whether this belongs to a hazardous situation or not. This then has to be reproduced for a positive example 28a in step S4, otherwise it is a negative example 28b. The meaning of positive example 28a and negative example 28b has thus shifted here; a positive example 28a is here no longer a recognized hazard, but the correct estimation of the dangerous situation corresponding to the initial knowledge of the training image subject to interference; correspondingly a negative example 28b is the lack of ability to reproduce this initial knowledge. The classification also does not have to remain binarily restricted to positive examples 28a and negative examples 28b. Quantitative figures of quality on the different interference properties can also be trained and also be output later, either to be able to understand the binary decision (explainable A1) or to allow a subsequent binary decision using the figure of quality.

Steps S2-S4 can be iterated with the interference being amplified from step to step, either by adding a interference property or by an increased interference intensity. The borderline case can thereby be found of how much interference the later evaluation will tolerate and thus a sufficient number of training examples for images will also be produced by which the detection capability is not given. A further, external iteration over steps S1 to S4 works through a plurality or all of the training images 20 not subject to interference of the database.

In a step S5, the labeled training examples thus produced are used to train a neural network for the detection capability check. It may be sensible to use a plurality of neural networks that are specialized in specific interference properties. In particular the training dataset corresponding to the interference properties that have entered into its creation is split up for this purpose. There are, for example, interference properties that relate to local properties such as blurred edges and others that have a global effect such as the swapping over of both image halves. Different network architectures are then possibly of advantage for this.

It has been mentioned a plurality of time that the invention has been explained for the example of the camera 10 with its 2D images, but other sensors are also possible. Different interference properties are then preferably also considered. In the case of a 3D sensor, it is moreover conceivable to use different data for the detection capability check and its training, for instance raw phase shifts of a phase-based time of flight process, than for the later estimation of a hazard that then works with 3D point clouds, for example.

The check in the later operation of the safety application of whether there is a hazardous situation can be carried out with any desired evaluation, for instance an object detection using classical image processing, a protected field expansion, an object tracking, and the like. The use of a neural network or of another process of machine learning is, however, also conceivable here. Its training can even be at least partially based on the training data of the detection capability check. It is further conceivable to subsequently train a neural network for an object detection or another evaluation of the danger situation by the detection capability check so that it has a dual function. It may be necessary for this to modify the architecture a little to obtain additional outcomes for figures of quality. Some known neural networks known per se and not exclusive that may be suitable for the detection capability check, in particular in conjunction with an object detection, are Yolo (you only look once), MobileNet, ResNet, and PoseNet.

1. A method of safeguarding a machine in which a sensor monitors the machine and generates data thereon that are evaluated so that a hazardous situation is recognized and the machine is safeguarded in the event of a hazardous situation, wherein a check is made in a detection capability check whether an estimation of a hazardous situation is possible and the machine is otherwise safeguarded,
wherein the sensor data are evaluated in a process of machine learning having at least one figure of quality in the detection capability check and an estimation of a hazardous situation is only considered possible with a sufficient figure of quality.

2. The method in accordance with claim 1,
wherein the figure of quality is binary.

3. The method in accordance with claim 1,
wherein the figure of quality quantitatively evaluates at least one interference property of the sensor data.

4. The method in accordance with claim 1,
wherein the process of machine learning has a classifier.

5. The method in accordance with claim 1,
wherein the process of machine learning has a neural network.

6. The method in accordance with claim 1,
wherein the sensor is a camera or a 3D sensor.

7. The method in accordance with claim 1,
wherein the evaluation of the sensor data has an object detector.

8. The method in accordance with claim 7,
wherein the object detector is configured to recognize foreign objects in the environment of the machine.

9. The method in accordance with claim 1,
wherein the process of machine learning is trained by supervised learning in which a plurality of training examples from sensor data having a known associated figure of quality are used as the training data.

10. The method in accordance with claim 7,
wherein the training examples are changed by at least one interference property at at least one interference intensity to generate further training examples.

11. The method in accordance with claim 10,
wherein the sensor data have images and at least one of the following interference properties is used: Image at least regionally too light or too dark, image at least regionally blurred, movement artefacts, static or/and dynamic image noise, image regions swapped over, address errors, image incomplete.

12. The method in accordance with claim 10,
wherein the training data are evaluated to determine whether a hazardous situation has been recognized despite the interference property and to associate a figure of quality with the training example depending on the result.

13. The method in accordance with claim 12,
wherein the training data are evaluated by an object detector.

14. The method in accordance with claim 12,
wherein the training data are evaluated by the same process that is also used for recognizing a hazardous situation in the safeguarding of the machine.

15. The method in accordance with claim 10,
wherein the training data are changed with increasing interference intensity and/or different interference properties until an evaluation of the changed training data no longer recognizes a hazardous situation.

16. The method in accordance with claim 9,
wherein a figure of quality is already associated with training examples corresponding to a no longer present detection capability in which the evaluation has still recognized a hazardous situation to provide a safety margin.

17. The method in accordance with claim 1,
wherein the evaluation of the sensor data for recognizing a hazardous situation likewise has a process of machine learning.

18. The method in accordance with claim 17,
wherein the process of machine learning is a process of machine learning of the detection capability check in a dual function.

19. A safeguarding system for safeguarding a machine that has at least one sensor for monitoring the machine and for generating sensor data and at least one control and evaluation unit in which a method
of safeguarding a machine
is implemented, in which method the sensor monitors the machine and generates data thereon that are evaluated so that a hazardous situation is recognized and the machine is safeguarded in the event of a hazardous situation, wherein a check is made in a detection capability check whether an estimation of a hazardous situation is possible and the machine is otherwise safeguarded,
wherein the sensor data are evaluated in a process of machine learning having at least one figure of quality in the detection capability check and an estimation of a hazardous situation is only considered possible with a sufficient figure of quality.
